(19) United States
(12) Patent Application Publication
(10) Pub. No.: US 2007/0177633 A1
(43) Pub. Date: Aug. 2, 2007

(54) Voice speed adjusting system of voice over Internet protocol (VoIP) phone and method therefor

(75) Inventors: Min-Chieh Wu, Taipei City (TW); Lan-Shin Lin, Taipei City (TW)

Correspondence Address: BIRCH STEWART KOLASCH & BIRCH, PO BOX 747, FALLS CHURCH, VA, 22040-0747, US

(73) Assignee: INVENTEC MULTIMEDIA & TELECOM CORPORATION

(21) Appl. No.: 11/341,490

(22) Filed: Jan. 30, 2006

(51) Int. Cl. H04J 1/16; H04J 3/06

(52) U.S. Cl. 370/516; 370/252

(57) ABSTRACT

A voice speed adjusting system of VoIP phone and the method therefor are provided. When the parameter for adjusting the voice playing speed of IP phone is set to a setting module at a receiving end, an adjusting module is used to adjust the voice data stored in a cache accordingly. The adjusted voice data are processed and encoded/decoded by a CPU. An output module is used for outputting the adjusted voice data according to the speed parameter. A prompting module at the sending end displays that the receiving end is adjusting the voice speed. That is, a conversation can be conducted at an appropriate speed and the sending end can also receive a message of voice speed adjustment at the receiving end.

### BACKGROUND OF THE INVENTION

1. Field of Invention

The invention relates to a voice speed adjusting system of a VoIP phone and the method therefor. In particular, the invention relates to a system that enables the user to determine the playing speed of the received voice data using a real-time voice signal processing technique and the method therefor.

2. Related Art

The conventional voice transmission method is to establish a fixed circuit line and then people can start a conversation over this circuit line. One drawback is that once the transmission resources are occupied, the line cannot be used by other people until the conversation is over. However, using the voice over Internet protocol (VoIP) technology, the voice is first digitized and severed into many small units. Each small unit adds an Internet protocol (IP) and then to be wrapped into a packet.

Once the IP packets are transmitted to an IP-based data network, appropriate transmission paths are formed according to the network usage. Once they reach their destinations, the packets are assembled to restore the original voice. Using this technology, the voice packets can be transmitted all over the world through the Internet, without using the conventional public switched telephone network (PSTN).

The primitive VoIP technology is very simple and limited in use. For example, one cannot directly use a telephone set for a VoIP communication, but it is only limited to computers as the communication device. Besides, voice quality is unstable, depending upon the traffic on the Internet. However, since the user does not need to pay for long-distance calls to communicate with people all over the world, more and more people adopt this technology for communication.

Until 1998, a switch for integrating telecommunication networks has been introduced, so that the VoIP technology can completely integrate with the conventional PSTN. Using the VoIP technology, the telecommunication carriers can use the Internet as the transmission backbone of long-distance phone calls, greatly lowering the long-distance phone call charge. As the VoIP technology becomes mature, many multi-national corporations have abandoned traditional long-distance calls and, instead, establish internal voice transmission networks. On the other hand, the telecommunication development policies in different areas or countries have also enabled some smaller telecommunication companies to prosper. They tacitly utilize the VoIP technology to provide cheaper communication services for their customers.

During phone conversations in the past, the user often has difficulties in comprehending the other party because of environmental noises, talking speed, or language problem, so the user has to ask the other party to repeat the conversation content over and over again. Especially for the VoIP technology, voice transmission via packets experiences intermittent breaks due to insufficient bandwidths happening all time. Therefore, it is important to be able to adjust the receiving speed of the conversation so that the voices can be more clearly transmitted for the receiver to listen. In particular, if the receiving speed can be slowed down or the blank space between each two sentences can be shortened so that the users can adjust the conversation speed according to personal preferences, the receiver can listen better voices in different speeds or languages.

### SUMMARY OF THE INVENTION

In view of the foregoing problems, it is an object of the invention to provide a voice speed adjusting system of VoIP phone and the method therefor. By adjusting the voice signals received by the IP phone and outputting the adjusted voices, the user at the receiving end can obtain better conversation effects. The sending end can also receive the notification of voice speed adjustment from the receiving end and make adjustments accordingly.

To achieve the above object, a voice speed adjusting system of VoIP phone disclosed herein includes at least: a setting module for receiving voice speed adjusting parameters set by the user; a transmitting module for receiving compressed and encoded voice data packets transmitted from the sending end and transmitting a prompt signal of voice speed adjustment to the sending end; a cache for storing the voice signals transmitted from the sending end; a central processing unit (CPU) for processing the voice speed adjustment; a prompting module for prompting a message according to the prompting signal; an adjusting module for compressing and decompressing the voice signals into voiceprint signals and adjusting each unit of the voiceprint signals according to the voice speed adjusting parameters; and an outputting module for playing the adjusted voice signals.

According to the object of the invention to achieve the above-mentioned advantages, the disclosed method includes the following steps. After the voice adjusting function is initialized, the system first receives setting of voice speed adjustment from the user. Afterwards, the prompt of the voice speed adjusting function being started at the receiving end is sent to the sending end. According to the adjusting parameters, the voice signals in the cache at the receiving end or the sending end are adjusted. Finally, the system outputs the adjusted voice signals.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 shows a system block diagram of the invention;

FIG. 2a is a schematic view of the invention playing at the normal speed;

FIG. 2b is a schematic view of the invention playing at a slow speed;

FIG. 2c is a schematic view of the invention playing at a fast speed; and

FIG. 3 is a flowchart showing the disclosed method implemented at the receiving end of an embodiment.

### DETAILED DESCRIPTION OF THE INVENTION

This specification discloses a voice speed adjusting system of VoIP phone and the method therefor. Various kinds of specific details are described herein to provide a complete explanation of the invention. However, a person skilled in the art can readily implement the invention without knowing such details, using equivalent devices or methods. Descriptions of well-known methods, procedures, components, and circuits are omitted herein in order to avoid unnecessary confusions.

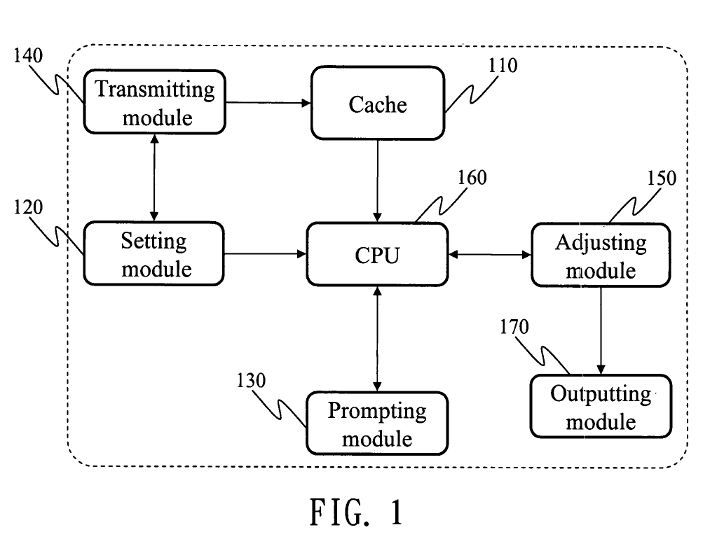

As shown in the system block diagram in FIG. 1, the invention includes the following elements.

The cache 110 is a random access memory (RAM), such as dynamic random access memory (DRAM), extend data out dynamic random access memory (EDO DRAM), Rambus DRAM (RDRAM), synchronous DRAM (SDRAM), virtual channel memory SDRAM (VCM SDRAM), and the latest popular double date rate SDRAM (DDR) on the market. It is used to temporarily store the voice stream data received by the transmitting module 140.

In addition to receiving voice packets transmitted from the sending end, the transmission module 140 can also receive and send the prompt of voice speed adjustment set at the receiving end. When the voice data are severed into several packets and sent out, the header is added with the IP address of the receiving end and information related to voice data recombination in order to ensure the data safety and correctness in data exchanges. Therefore, the VoIP service needs an important standard called the signaling protocol to establish the connection between the software and hardware of the customers. The primary functions of the establishment and control of session requests include user address searches, address conversions, connection establishment, services negotiation, call termination, and management of callers.

The organizations of the VoIP standard include ITU-T, the Internet Engineering Task Force (IETF), and the European Telecommunications Standards Institute (ETSI). Two notable standards used for VoIP signal transmissions are the H.323 series standard of ITU and the Session Initiation Protocol (SIP) of IETF. The protocol is originally developed for multimedia conferencing over the internet. H.323 and SIP represent two different solutions to similar problems. Besides, there are two signaling protocols considered as part of the SIP structure. They are the Session Description Protocol (SDP) and the Session Announcement Protocol (SAP).

The establishment and control of VoIP calls are mostly built upon the TCP basis. The voice stream transmissions are built upon the UDP basis. To ensure the real-time nature of the transmissions, IETF adds an important protocol, the Resource Reservation Protocol (RSVP). Generally speaking, reserving sufficient bandwidths on the Internet for multimedia transmissions is quite difficult. IETF defines the Resource Reservation Setup Protocol (RSVP). The RSVP enables the receiver to apply for specific bandwidths for data transmissions. This guarantees the quality of services (QoS).

The setting module 120 is used to receive settings entered by the user from a keyboard or some other input devices. For example, the user can start the voice adjusting function from the keyboard, selecting a factor to speed up or slow down the voice speed, starting the prompting function, and sending parameters to the CPU 160 for the next adjustment.

The prompting module 130 displays a message of the-voice speed adjusting function being started on the sending end when the receiving end starts the voice speed adjusting function and a prompting signal set at the receiving end is received. The message can be displayed on a screen, indicated by a specific light, or prompted via audio effects, and so on.

The adjusting module 150 is used to receive the voice signals transmitted from the transmitting module 140 at the receiving end when the voice speed adjusting function is initialized. According to the voice speed adjusting parameter set by the user, different numbers of units of voiceprint data (30 ms as a unit) are duplicated or the analog voice signals received by the microphone of the sender are converted into digital voice signals. Then, according to the voice speed adjusting parameter transmitted from the receiving end, the voice signals are then duplicated many times based on the adjusting factor. Alternatively, when the module compresses and encodes the voice signals, the number of duplicated voice signals can be added into the transmitted packet. When the receiving end receives the packets and performs packet assembly, the task can be adjusted according to the number of duplication.

The CPU 160, using a digital signal processing (DSP) technique such as the voice coding and voice compression, is used to encode voice signals into digital voice signals. The digital signals are then compressed, and severed to be packetization. Each packet is transmitted independently on the digital network. The receiving end performs packet assembly, de-packetization, and decompresses the received packets. The digital voice signals are converted back to analog signals for playing.

When the user wants to increase the voice playing speed, the CPU 160 increases the playing speed of the received voice signals by the corresponding factor. For example, when the increasing factor is 2, one of two consecutive voiceprint signals is abandoned. In this way, the voice data are reduced by a factor of two and the overall voice playing speed is increased. Likewise, if the user decreases the playing speed by a factor of 2, each voiceprint signal is duplicated once and the blank space between each two sentences is shortened. If necessary, the overall playing time can be elongated.

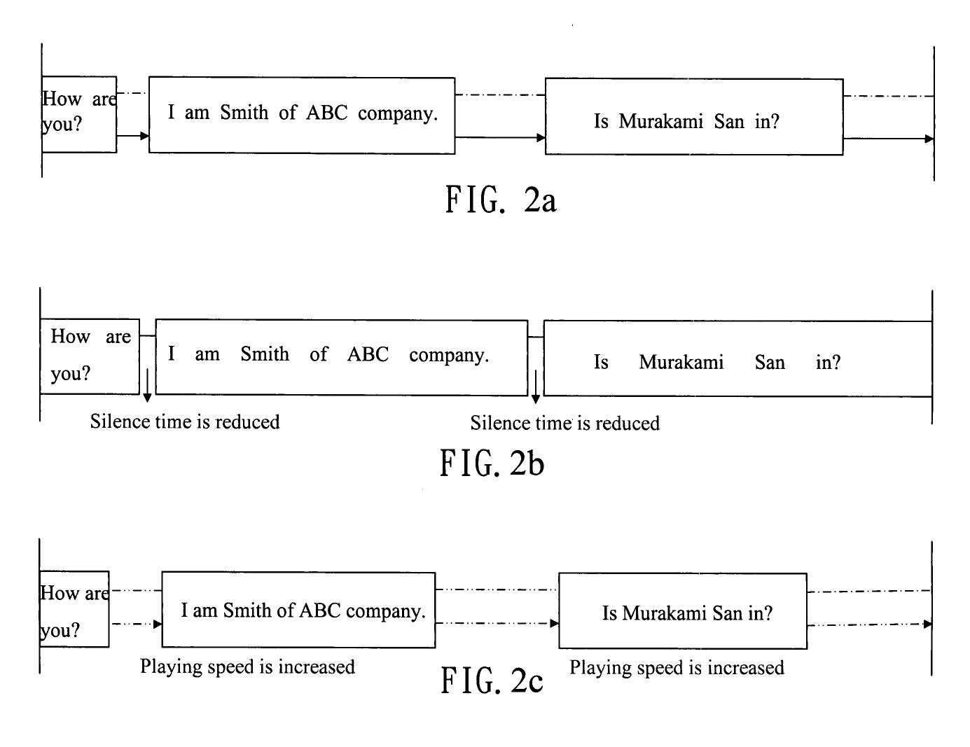

The outputting module 170 refers to the amplifier on the VoIP phone for playing the digital voice signals. FIG. 2a illustrates voice playing at the normal speed. Suppose the received voice signals contain three sentences: “how are you?”, “I am Smith of ABC company”, and “Is Murakami San in?” A blank space exists between each two sentences. When the user selects to play at a lower speed, as shown in FIG. 2b, the adjusting module 150 duplicates the voiceprint signals according to the voice adjusting parameter set by the user. Therefore, the break time between sentences is shorter. It is even possible that the overall playing time of the three sentences is longer than the normal time. Since the prompting module 130 at the sending end can know whether the receiving end has started the voice adjusting function. The user can know whether the answer from the receiving end will be slower than normal. Likewise, when the user at the receiving end selects to increase the playing speed, as shown in FIG. 2c, then the playing time of each sentence becomes shorter according to the playing speed parameter. The beginning time of each sentence is kept the same. Thus, the silent time between the sentences is longer.

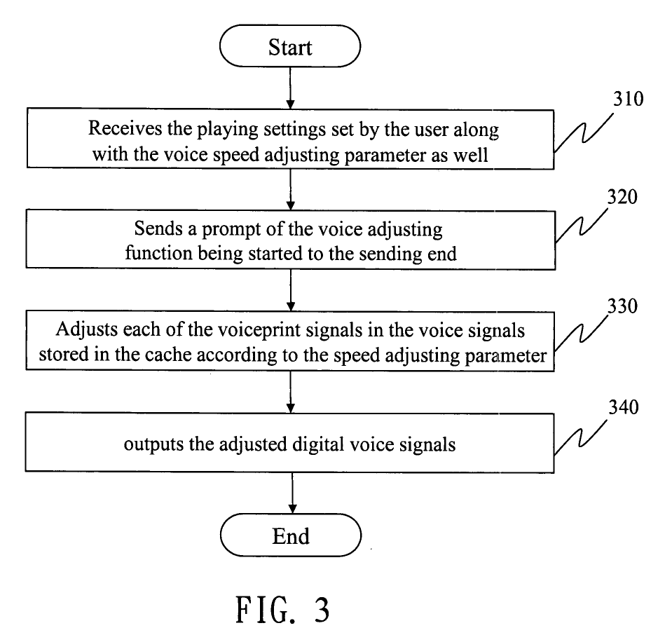

With reference to FIG. 3, it shows a flowchart showing the disclosed method implemented at the receiving end. Once the user starts the voice adjusting function at the receiving end, the setting module 120 at the receiving end receives the playing settings set by the user along with the voice speed adjusting parameter as well (step 310). Afterwards, the transmitting module 140 sends a prompt of the voice adjusting function being started to the sending end (step 320). The prompting module 130 at the sending end may use a message, indicator, or voice to notify the user at the sending end.

The transmitting module 140 receives the voice packets. The packets are assembled into voice signals and then store in the cache 110. The adjusting module 150 adjusts each of the voiceprint signals in the voice signals stored in the cache 110 according to the speed adjusting parameter (step 330). For example, if the speed adjusting parameter is 2, then one unit of voiceprint signal is removed from two consecutive voiceprint signals. The voice data are reduced by a one-half, thereby speeding up the voice playing. Finally, the outputting module 170 outputs the adjusted digital voice signals (step 340). The user at the receiving end can hear the adjusted voices of the sending end from the outputting module 170 once the data are received from the transmitting module 140.

The disclosed method enables the receiver to adjust the voice playing speed according to the speaking speed of the speaker and personal needs during a VoIP session. The sending end can also receive a prompt of the voice adjusting function being started at the receiving end.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A voice speed adjusting system of voice over Internet protocol (VoIP) phone used between a sending end and a receiving end, comprising:
a setting module for receiving a plurality of voice speed adjusting parameters set by a user;
a transmitting module for receiving a plurality of compressed and encoded voice data packets transmitted from the sending end and re-assembling them into a voice signal, and transmitting the voice speed adjusting parameters to the sending end, the voice signal being composed of a plurality of voiceprint signals;
a cache for temporarily storing the voice signal; and
an adjusting module for duplicating or removing some units of the voiceprint signals according to the voice speed adjusting parameters.

2. The system as claimed in claim 1, further comprising a prompting module for prompting messages according to the voice speed adjusting parameters.

3. The system as claimed in claim 1, further comprising a central processing unit (CPU) for compressing and encoding the voice signals and re-assembling the voice data packets.

4. The system as claimed in claim 1, further comprising an outputting module for playing the adjusted voiceprint signals.

5. The system as claimed in claim 1, wherein the voice speed adjusting parameters include an initialization of the adjusting function, a setting of increasing or decreasing the playing speed, and an adjusting factor.

6. A voice speed adjusting method of VoIP phone for re-assembling a voice signal and storing it in a cache after a receiving end receives a plurality of compressed and encoded voice data packets from a sending end, comprising the steps of:
receiving a plurality of voice speed adjusting parameters entered by a user;
reading the voice signal in the cache and dividing it into a plurality of voiceprint signals; and
adjusting the unit data of the voiceprint signals according to the voice speed adjusting parameters.

7. The method as claimed in claim 6, wherein the voice speed adjusting parameters include an initialization of the adjusting function, a setting of increasing or decreasing the playing speed, and an adjusting factor.

8. The method as claimed in claim 7, wherein the prompting module at the sending end prompts a message once the parameter of the initialization of the adjusting function is transmitted to the sending end.

9. The method as claimed in claim 6, wherein the voice signal adjusting method is to remove or duplicate each unit data of the voiceprint signals according to the setting of increasing or decreasing the playing speed.

10. The method as claimed in claim 9, wherein the unit data quantity is 30 Ms.
